(19) United States
(12) Patent Application Publication
(10) Pub. No.: US 2012/0323699 A1
(43) Pub. Date: Dec. 20, 2012

(54) Method for Generating a Satellite Readable Image for Linking to Information Over a Communications Network

(75) Inventor: Richard James Phillips, Austin, TX (US)

(73) Assignee: Phillips & Company

(21) Appl. No.: 13/494,666

(22) Filed: Jun. 12, 2012

Related U.S. Application Data
(60) Provisional application No. 61/496,148, filed on Jun. 13, 2011.

(51) Int. Cl. G06K 9/36; G06Q 30/02; G06K 19/06; G06F 17/00

(52) U.S. Cl. 705/14.69; 382/100; 715/205; 235/494

(57) ABSTRACT

A method is provided for advertising goods or services. The method includes the steps of (a) determining (603) the imaging schedule for imaging of a geographic region by an organization that captures images of geographic regions by aircraft or spacecraft, wherein the captured images are posted to a website; and (b) before and proximal to the scheduled imaging of the region, placing (605) a machine readable code in the region such that the machine readable code is present in at least one of the captured images as a machine readable artifact.

### CROSS-REFERENCE TO RELATED APPLICATION

This application claims the priority of U.S. Provisional Application No. 61/496,148, filed Jun. 13, 2011, which is incorporated herein by reference in its entirety.

### FIELD OF THE DISCLOSURE

The present disclosure relates generally to the dissemination of information through machine readable codes, and more particularly to systems and methods for linking to information over a network through the placement of machine readable codes on geographic images that are accessed over the network.

### BACKGROUND OF THE DISCLOSURE

The placement of advertisements on rooftops or expanses of land which are viewable from the air has been known to the art for some time. For example, several Target stores have been built with the chain's distinctive target symbol logos painted on their roofs. Similar rooftop advertisements of this type have been created for businesses and organizations such as Mercedes-Benz, Coca Cola, Home Depot, Ford, Dick's Sporting Goods and AT&T. Advertisements of this type have not been limited to buildings. Thus, KFC and Maxim Magazine have both had aerial advertisements for their respective organizations implemented on land in the Nevada desert.

Many of the foregoing advertisements were originally intended for view by the occupants of nearby skyscrapers or by airplane passengers traveling to or from nearby airports. However, the potential audience for advertisements of this type has broadened considerably in recent years, as high resolution satellite and aerial imagery has become widely available on the Internet. In particular, in addition to being viewable by their originally intended audience, the foregoing advertisements are sometimes visible in the geographical images used by websites and mapping tools such as Google Earth and MapQuest.

### BRIEF DESCRIPTION OF THE DRAWINGS

FIG. 1 is an illustration of an embodiment of a system in accordance with the teachings herein in which an artifact is captured during satellite imaging of a geographic region.

FIG. 2 is an illustration of an embodiment of a system in accordance with the teachings herein which may be utilized to disseminate captured images containing an artifact.

FIG. 3 is a flowchart of an embodiment of a method for disseminating information in accordance with the teachings herein.

FIG. 4 is a flowchart of an embodiment of a method for disseminating information in accordance with the teachings herein.

FIG. 5 is a flowchart of an embodiment of a method for accessing information in accordance with the teachings herein.

FIG. 6 is a flowchart of an embodiment of a method for advertising goods or services in accordance with the teachings herein.

FIG. 7 is a flowchart of an embodiment of a method for placing an artifact on a property in accordance with the teachings herein.

FIG. 8 is a flowchart of an embodiment of a method for placing an artifact on a property in accordance with the teachings herein.

### SUMMARY OF THE DISCLOSURE

In one aspect, a method is provided for disseminating information. The method comprises (a) providing an image of a geographical region having an artifact therein, wherein the artifact comprises a machine readable code which links to a webpage; and (b) publishing the image over a network.

In another aspect, a method is provided for disseminating information. The method comprises (a) inserting an artifact into an image of a geographical region used by a mapping tool on a website, thereby obtaining a modified image, wherein the artifact links to a webpage; and (b) publishing the modified image over a network.

In a further aspect, a method is provided for accessing information. The method comprises (a) accessing, over a network, an image of a geographical region which has an artifact therein, wherein the artifact comprises machine readable code which links to a webpage; and (b) browsing the image with a machine which reads the machine readable code.

In still another aspect, a method is provided for advertising goods or services. The method comprises (a) determining the imaging schedule for imaging of a geographic region by an organization that captures images of geographic regions by aircraft or spacecraft, wherein the captured images are posted to a website; and (b) before and proximal to the scheduled imaging of the region, placing a machine readable code in the region such that the machine readable code is present in at least one of the captured images as a machine readable artifact.

In a further aspect, a method for placing an artifact on a property is provided. The method comprises (a) identifying a plurality of candidate properties for the placement of an artifact that comprises a machine readable code which links to a webpage; (b) negotiating pricing terms for placement of the artifact on each of said plurality of candidate properties; (c) selecting at least one of the candidate properties for placement of the artifact; (d) determining the imaging schedule for imaging of a geographic region by an organization that captures images of geographic regions by aircraft or spacecraft, wherein the captured images are posted to a website, and wherein the geographic region contains at least one of the selected properties; and (e) before and proximal to the scheduled imaging of the region, placing the artifact on the at least one selected properties such that an image of the artifact is present in at least one of the captured images.

In yet another aspect, a method for placing an artifact on a property is provided. The method comprises (a) maintaining a database of properties for which the owner has agreed to pricing terms for the placement of an artifact on the property, wherein the database includes a unique identifier for each property listed, and the pricing terms associated with that property; (b) obtaining, from a client, a selection of at least one property from the database for the placement of an artifact; (c) determining the imaging schedule for imaging of a geographic region by an organization that captures images of geographic regions by aircraft or spacecraft, wherein the captured images are posted to a website, and wherein the geographic region contains at least one of the selected properties; and (d) before and proximal to the scheduled imaging of the region, placing the artifact on the at least one selected properties such that an image of the artifact is present in at least one of the captured images.

### DETAILED DESCRIPTION

While advertisements placed on rooftops and landscapes sometimes show up in the high resolution satellite and aerial images used by mapping websites and mapping tools (such as those provided by Google Earth and Mapquest), this result is somewhat speculative. In particular, advertisements of this type will only show up in such images if they are in place at the time when images of the region they reside in are captured. Hence, if it is desired for these advertisements to be captured in images of this type, it may be necessary to maintain the advertisement for a prolonged period of time. As noted in a Feb. 6, 2006 article entitled “Rooftop Ads Are Real Business” which appeared in the Advertising Lab blog, “There remains an issue of Google Maps updating the photos only once every few years, so we are talking about a long-term commitment.”

Moreover, advertisements placed on rooftops and landscapes may be subject to degradation over time by weather, ultraviolet radiation, pollution and other such environmental factors. Hence, if there is a significant delay between placement of the advertisement and its imaging, additional costs may be incurred in maintaining the advertisement or in renting the space it is placed on. Of course, if the advertisement is not properly maintained, its quality may be compromised by the time it is imaged.

Some attempts have been made in the art to address the foregoing issues and to more directly leverage websites and mapping tools by incorporating advertisements into the maps provided by these websites and tools. For example, U.S. 2010/0004995 (Hickman) discloses a technique for identifying groups of features in an online geographic view of a real property, and replacing or augmenting the groups of features with advertisement information.

In accordance with the technique disclosed in Hickman, a geographic view of the property is provided within an online property management system, and a region of interest in the geographic view is identified. The geographic view is analyzed to locate one or more promotional features within the geographic view which are positioned upon a real property region, and a user-selectable link is provided which is associated with the region of interest in the geographic view. A request is received for the region of interest in the geographic view via the user-selectable link, and data is received to alter at least one of the behavior or the appearance of the region of interest. The data is stored in association with the geographic view, and the region of interest is updated within the geographic view based upon the received data.

However, while the methodology of Hickman may be suitable for its intended purpose, insertion of an advertisement into, or over, an existing image of a geographical region may generate visual artifacts in the resulting image due, for example, to differences in resolution, lighting, saturation, orientation and hue between the original image and the insert. Moreover, this approach presumes a relationship with the entity that captures the geographical image and/or makes the image available on a website. However, such a relationship may not exist and, if it does, would typically involve the payment of a subscription or service fees. Finally, the amount of information that may be conveyed in the methodology as described in Hickman is limited.

It has now been found that the foregoing infirmities may be overcome, and additional advantages may be achieved, through the systems and methodologies disclosed herein. These systems and methodologies preferably utilize artifacts, which preferably comprise machine readable code, to disseminate information. An artifact of this type, which may link to a web page, may be disposed in an image of a geographical region. In some embodiments, the artifact may be disposed in the image by being placed in the geographic region when that region is imaged. In other embodiments, the artifact may be inserted into an existing image of a geographical region. In either case, the resulting image may then be used by a mapping tool on a website, or may be published over a network, thus disseminating the encoded information.

In other embodiments, an image of a geographical region which has an artifact therein may be accessed over a network. The artifact may comprise machine readable code which links to a webpage, and the image may be browsed with a device which reads the machine readable code. The device may then undertake various actions, such as creating a hyperlink to the webpage, redirecting the browser to the webpage, launching an application, or opening a window or dialog box.

In still other embodiments, the artifact may be a machine readable code which may be physically installed on a geographical feature, such as a building rooftop, a landscape or a geological feature which is subject to geographical imaging. The installation of the machine readable code is preferably arranged to occur before, and preferably proximal to, the time at which a set of geographical images is to be captured for the region in which the geographical feature is disposed. This ensures that the rendered artifact will be readable and in good condition at the time of imaging, and that any information it encodes will be timely and current.

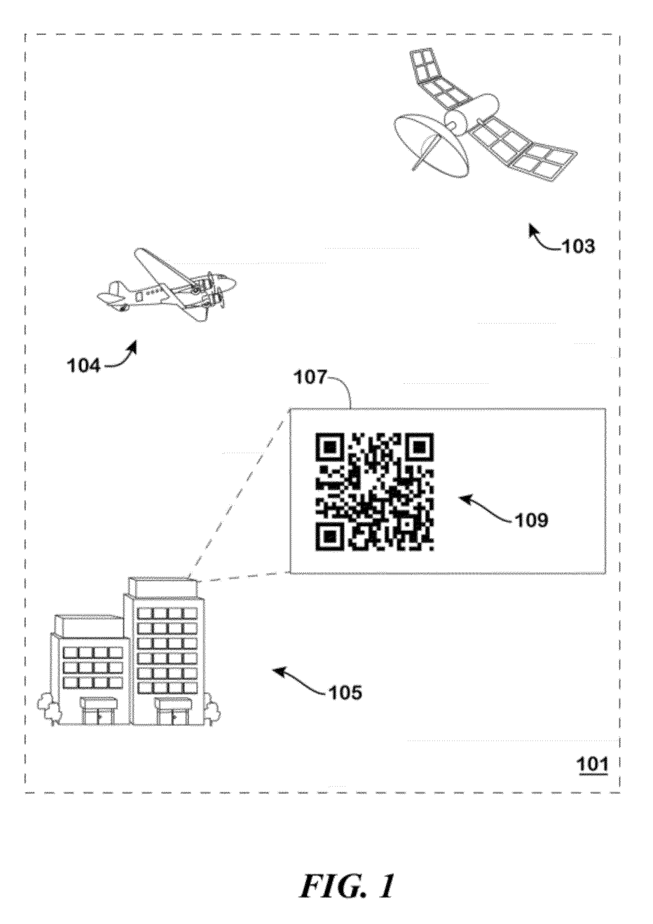

FIG. 1 depicts a particular, non-limiting embodiment of a system for imaging artifacts in accordance with the teachings herein. As seen therein, the system 101 includes a satellite 103 and/or aircraft 104 that captures images of geographic regions. In the particular situation depicted, the geographic region includes a building 105 having a rooftop 107 with an artifact 109 thereon. The particular artifact 109 depicted is a QR code which links to a webpage containing content. The artifact 109 is captured in the images taken by the satellite 103 or aircraft 104.

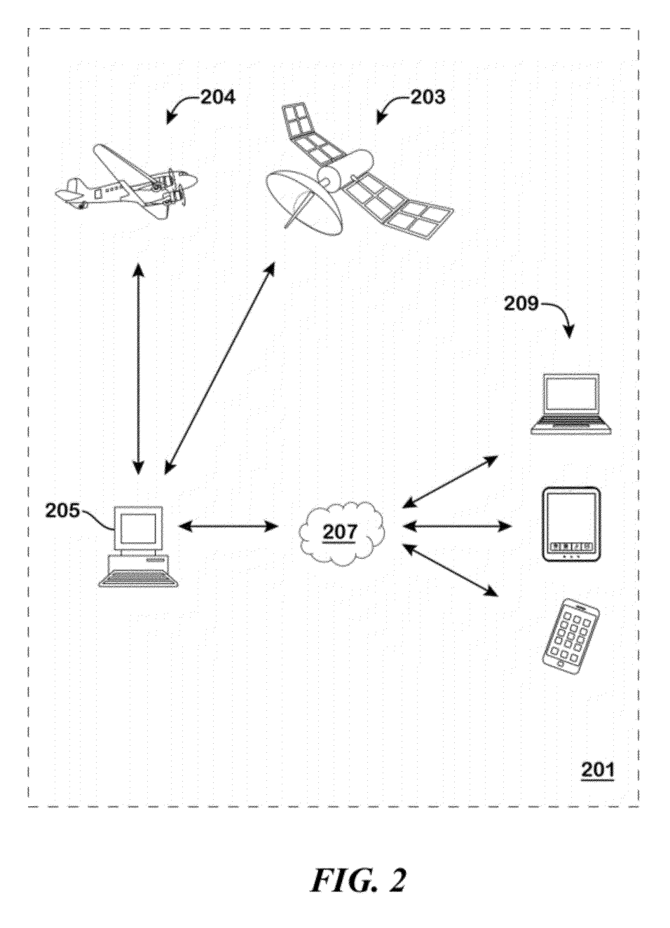

FIG. 2 depicts a particular, non-limiting embodiment of a system for publishing or distributing imaged artifacts in accordance with the teachings herein, including those obtained with a system of the type depicted in FIG. 1. As seen therein, the system 201 includes a satellite 203 and aircraft 204, which are preferably the same satellite 103 and aircraft 104 from FIG. 1. The satellite 203 and aircraft 204 transmit the images they capture to a ground based server 205. The ground-based server 205 is in communication with a plurality of end user devices 209 (depicted, for sake of illustration, as a laptop, a table PC and a mobile phone) by way of a network 207.

The network 207 may be any suitable network including, for example, the Internet. Thus, for example, the end user devices 209 may be browsing a mapping site on the Internet to which the images captured by the satellite 203 and aircraft 204 are posted, possibly as part of a mapping site or mapping tool such as those provided, for example, by Google Earth or MapQuest. The end user devices 209 may be equipped with software that recognizes the imaged artifact or the code therein. Thus, for example, in the particular embodiment illustrated, such software may be adapted to read or capture QR codes, to perform certain actions when such codes (or items generated from the code, such as hyperlinks) are recognized in an image or are selected by the user (such actions may include, for example, opening a website or webpage encoded in the code), or to provide a hyperlink to a website or webpage encoded in the code and to embed the hyperlink over the imaged artifact in the picture (or to provide the hyperlink elsewhere on the screen).

It will be appreciated from the foregoing that the system 101 of FIG. 1 provides a means for capturing geographic images that contain (or are later modified to contain) one or more artifacts. The system 201 of FIG. 2 then provides a means for distributing or publishing these images (and the artifacts contained therein) over a network to consumers, to the public at large, or to an intended audience. The systems 101 and 201 of FIGS. 1 and 2, respectively, thus provide the infrastructure for the implementation of a variety of processes and methodologies including, but not limited to, methods for disseminating information, accessing information and doing business. Some of these methods are described in greater detail below.

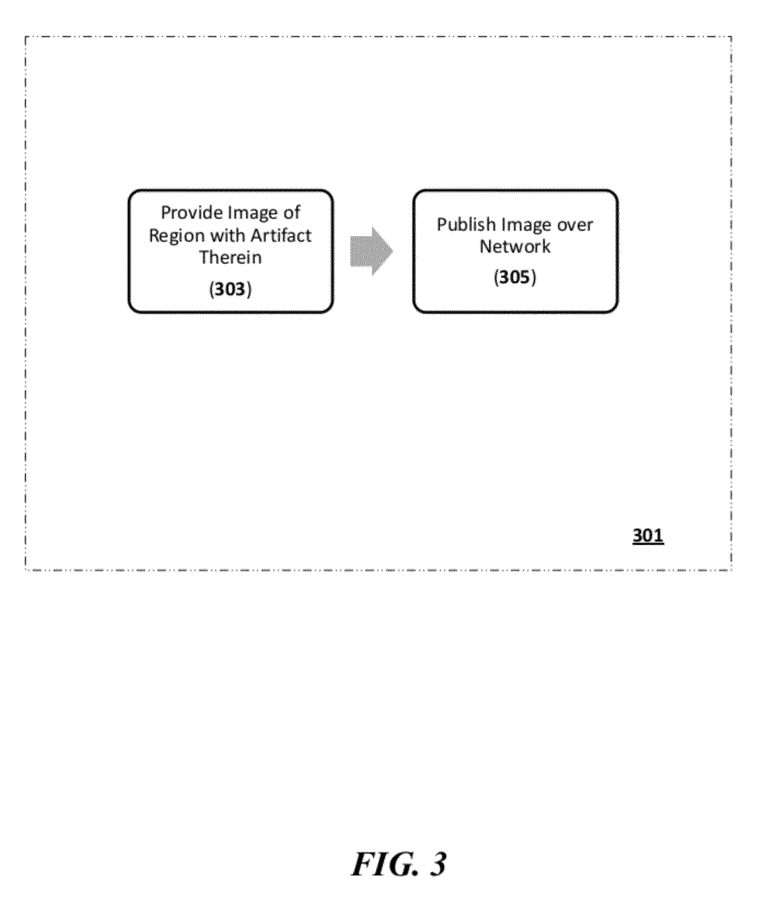

FIG. 3 illustrates an embodiment of a methodology for disseminating information in accordance with the teachings herein. In the embodiment 301 depicted, an image is provided 303 of a geographic region having an artifact therein. The image may be captured at a desired resolution (or resolutions) using any of the methodologies described herein, including its capture by aircraft or spacecraft. The image is then published 305 over a network. Publication may include, for example, posting the image on a website.

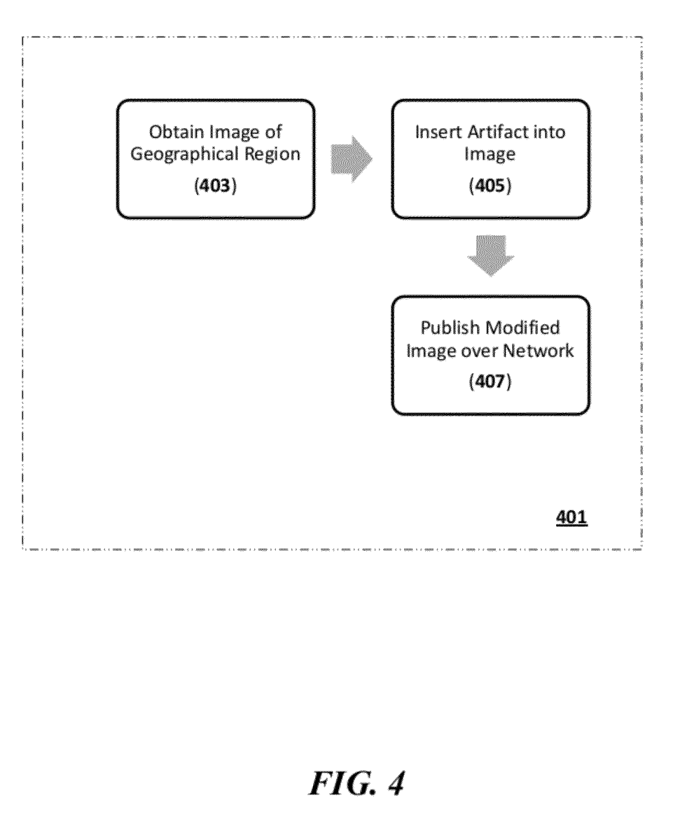

FIG. 4 illustrates another embodiment of a methodology for disseminating information in accordance with the teachings herein. In the embodiment 401 depicted, an image is obtained 403 of a geographic region. The image may be captured at a desired resolution (or resolutions) using any of the methodologies described herein, including its capture by aircraft or spacecraft, or may be obtained from a party that captures images in any suitable manner.

An artifact is then inserted 405 into the image. The artifact preferably includes a machine readable code that encodes information, such as the address of, or link to, a web page which contains information of interest. The artifact may be inserted, for example, through the use of image editing software, which may include, for example, the insertion of the artifact into a first image layer that overlies a second image layer, wherein the second image layer contains the image of the geographic region (or a portion of that image or region). The modified image is then published 407 over a network. Publication may include, for example, posting the modified image on a website, or including the modified image in a tool that is available or utilized over a network.

It will be appreciated that the methods of disseminating information which are depicted in FIGS. 3-4 may be utilized for a variety of purposes. For example, these methods may be used to create public awareness of an event or cause, as part of an advertising campaign, or as part of a consumer education campaign.

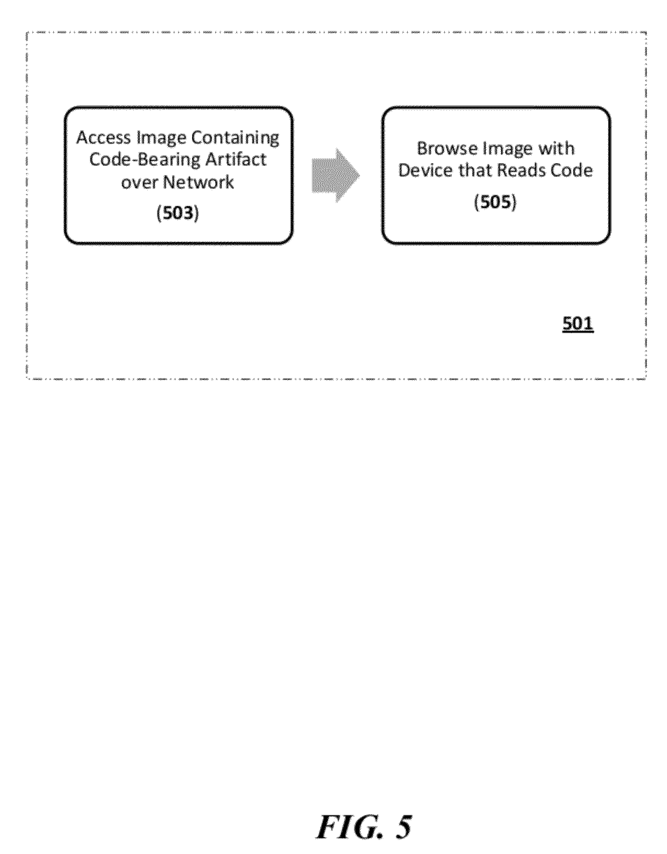

FIG. 5 illustrates an embodiment of a methodology for accessing information in accordance with the teachings herein. In the embodiment 501 depicted, an image which contains a code-bearing artifact is accessed 503 over a network, and is browsed 505 with a device that reads the code. By way of example, the image may be of a geographic region, which may be browsed on a mapping website. The code bearing artifact may be, for example, a building having a code (such as, for example, a QR code) painted or otherwise rendered or disposed on the roof thereof. The device may be, for example, a laptop, a desktop or tablet PC, a mobile communications device, or the like.

The image may be browsed, for example, by a web browser and/or by other software having a browsing functionality. Preferably, the software used to browse the image has the ability to recognize the code embedded or contained in the image. Upon recognizing the code, the software may undertake suitable actions such as, for example, generating a hyperlink, placing a marker or token on the image, or generating a pop-up when a cursor is moved over the imaged artifact.

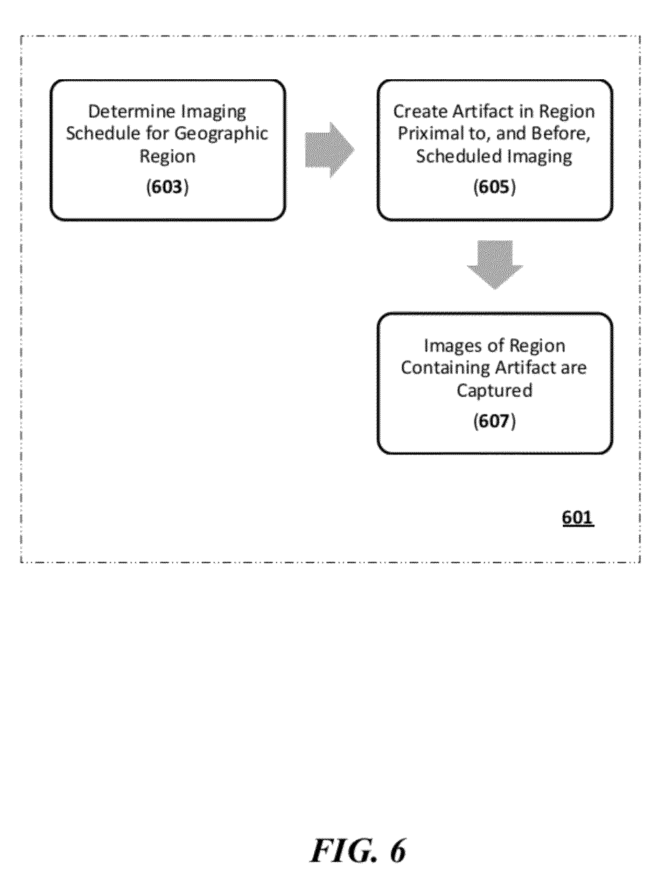

FIG. 6 illustrates an embodiment of a methodology for advertising goods or services in accordance with the teachings herein, though the methodology may be used for other kinds of information dissemination as well. In the embodiment 601 depicted, the imaging schedule for a geographic region is determined 603 for a company that captures geographic images for posting to a website or for use in conjunction with a web tool (such as, for example, a mapping tool). An artifact is then created in the region proximal to, and before, the time at which the imaging for the region is scheduled to occur. Images of the region (and the artifact contained therein) are subsequently captured, and may be disseminated to the general public or to other parties of interest using the various systems and methodologies described herein.

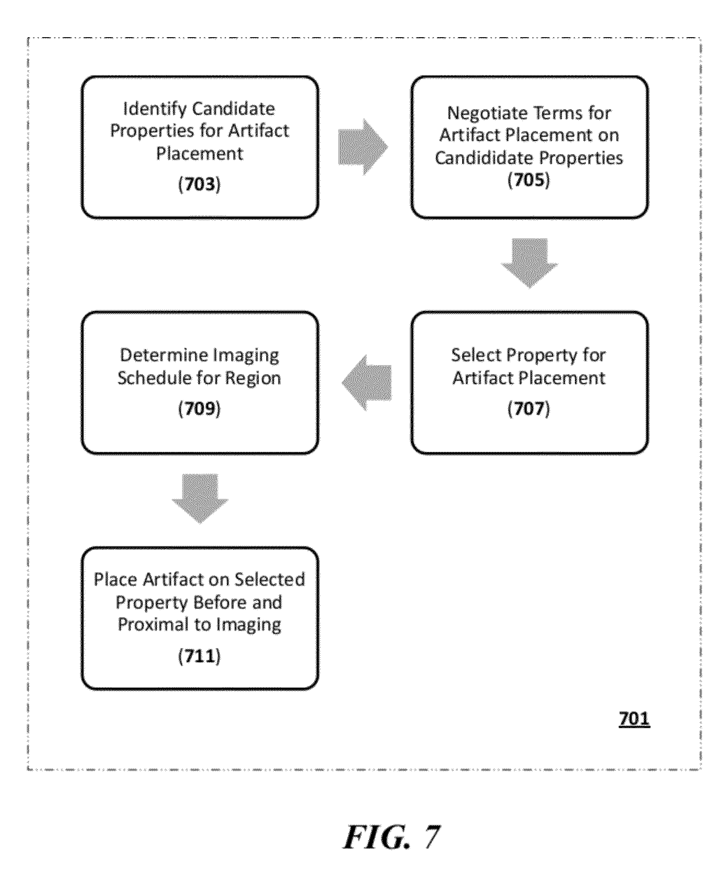

FIG. 7 illustrates an embodiment of a methodology for placing an artifact on a property in accordance with the teachings herein. This methodology may be part of a more general method for doing business. In the embodiment 701 depicted, candidate properties for the placement of an artifact are located 703, and terms are negotiated 705 for the placement of an artifact on each of the candidate properties. The candidate properties and negotiated terms may be maintained in a first database, wherein each candidate property is preferably assigned a unique identifier.

A property is then selected 707 for placement of an artifact thereon. The imaging schedule for the geographic region in which the artifact is placed is then determined 709, possibly from scheduling information maintained in a second database. An artifact is then placed 711 on the property before, and preferably proximal to, the time at which the geographic region in which the artifact is placed is scheduled for imaging.

In some instances, the methodology of the foregoing embodiment may be implemented by multiple business entities having various relationships between them. For example, a first business entity may be involved with identifying properties for artifact placement. This business entity may also handle the negotiation of terms (for example, rate, duration, and limitations on the types of artifacts permitted) for artifact placement with the owners of the respective properties. This information may then be stored in the first database.

A second business entity may work with clients to select a property, from among the properties listed in the first database, for the placement of an artifact. Selection of a property in a particular case may involve, for example, consultation with the client, or consideration of the client's stated needs. A third business entity may be involved with determining the imaging schedule for the region into which the artifact will be placed, and a fourth business entity may be involved with the actual placement of an artifact on the selected property.

Of course, it will be appreciated that any of the foregoing business entities may be the same or different and that, in particular, two or more of these businesses may be the same business. It will also be appreciated that a single client may be interested in the placement of multiple artifacts (or multiple copies of the same artifact), and that a single property may host one or more artifacts.

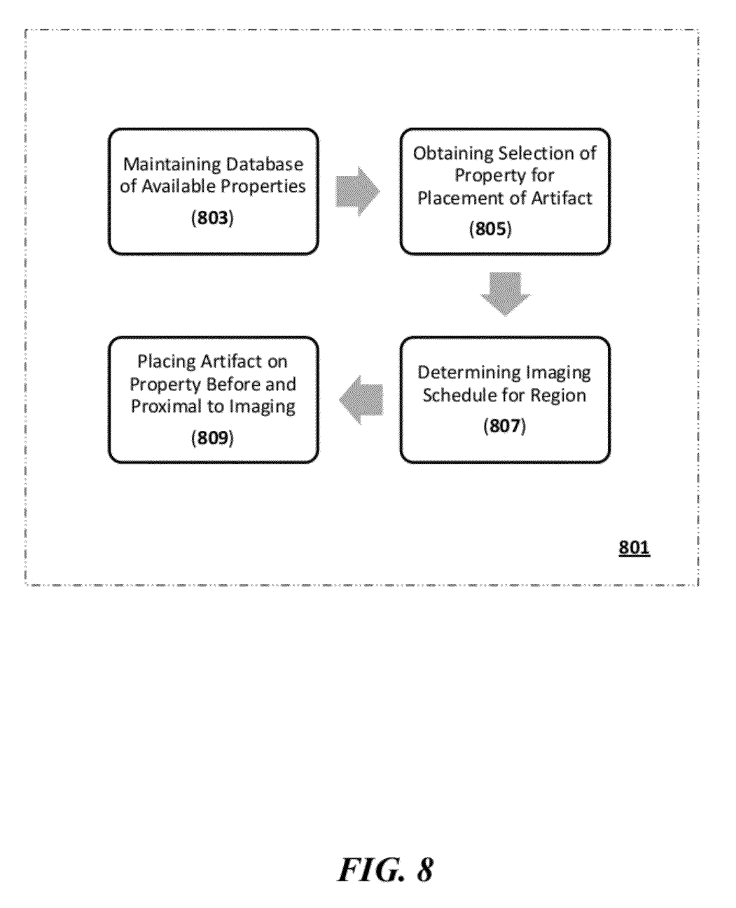

FIG. 8 illustrates another embodiment of a methodology for placing an artifact on a property in accordance with the teachings herein. In the embodiment 801 depicted, a database of properties available for the placement of an artifact thereon is maintained 803. A selection 805 of a property in the database is obtained, preferably from a party requesting placement of the artifact. The imaging schedule is then determined 807 for the geographic region into which the artifact is to be placed. The artifact is then placed 809 on the property before, and preferably proximal to, the date on which the geographic region is scheduled for imaging.

The artifacts described herein may be created on a variety of geographical features. While the use of building rooftops as a geographical feature is preferred, other geographical features may also be utilized including, but not limited to, parking lots, roadways, bridges, parcels of land, prominent geological features (such as, for example, hilltops, ridges, fields, or expanses of desert), and other such features as are subject to geographical imaging.

The artifacts described herein may be generated in a variety of ways and may be created in a variety of media. For example, the artifacts may be created from physical items, such as bricks, shopping carts, bales of hay, vehicles, and other such items. The artifacts may also be projected on a geographical feature using a variety of projection techniques as are known to the art, such as laser projection. The artifacts may also be painted, drawn, embossed, or otherwise imparted to a substrate. The substrate may be the geographic feature itself, or it may be a film, fabric, sheeting, canvas, or other suitable medium which is placed on the geographic feature.

The systems and methodologies disclosed herein may be utilized with geographical images captured in various ways. For example, such geographical images may be captured by various types of spacecraft (such as satellites), aircraft, weather balloons, or a combination of the foregoing.

The captured images utilized in the systems and methodologies described herein may have various resolutions. Typically, the resolution of the captured images is at least 20 m/pixel, preferably at least 15 m/pixel, more preferably at least 5 m/pixel, even more preferably least 2.5 m/pixel, and most preferably at least 0.5 m/pixel. However, the systems and methodologies disclosed herein may be adapted to operate with varying image resolutions, or with a mixture of resolutions.

Various machine readable codes may be utilized in the systems and methodologies described herein. These machine readable codes are preferably optically readable codes which encode data about a given subject, such as a link to a web page. These machine readable codes may be linear or one-dimensional codes such as UPCs (universal product codes), or may be two-dimensional or matrix codes. The machine readable codes may comprise parallel lines of varying widths, spacings or colors, or may comprise dots, circles, ellipses or polygons (including rectangles and hexagons) which may also have varying widths, spacings or colors.

Specific examples of machine readable code which may be utilized in the systems and methodologies described herein include 3-DI, ArrayTag, Aztec code, Codablock, ColorCode (color barcodes that can be read from television monitors by camera phones), Color Construct Code (a barcode symbology that leverages multiple colors), Compact Matrix Code, CP Code, CyberCode, Code 1, Code 16K, Code 49, DataGlyphs (symbiology that can be embedded in a half-tone image or background shading patter to make it almost perceptually invisible, though still machine readable), data matrix code, Datastrip Code, Dot Code A, EZcode, Grid Matrix Code, HD Barcode, High Capacity Color Barcode, HueCode (which uses grayscale or color), Intacta.Code, InterCode, JAGTAG, MaxiCode, mCode, MiniCode, MicroPDF417, MMCC, Nintendo e-Reader#Dot code, Optar, PaperDisk, PDF417, PDMark, QR Code, QuickMark Code, Secure Seal, SmartCode, Snowflake Code, ShotCode, SPARQCode, WaterCode, Trillcode, UltraCode, UnisCode, VeriCode, VSCode, and SuperCode.

The use of QR (quick response) codes is preferred in the systems and methodologies described herein, due to the reproducibility of these codes on (and the readability of these codes from) a variety of surfaces, and the ability of a QR code to allow its contents to be decoded at high speeds. QR Codes are a type of matrix barcode (or two-dimensional code) which consists of black modules (square dots) arranged in a square pattern on a white background. The information encoded in a QR code can consist of four standardized kinds (or “modes”) of data: numeric, alphanumeric, byte/binary and Kanji). However, virtually any kind of data may be represented in a QR code through supported extensions.

A QR code may be detected as a 2-dimensional digital image by a semiconductor image sensor, and then digitally analyzed by a programmed processor. The processor locates the three distinctive squares at the corners of the image, and normalizes image size, orientation, and angle of viewing. The small dots are then converted to binary numbers and validity checked with an error-correcting code.

The machine readable codes may be adapted to be read by various machines. Preferably, these codes will be readable by scanners or cameras, possibly in conjunction with interpretive software, and are preferably optically readable. The machine readable codes may also be displayed on a first device and read or decoded on a second device. For example, the codes may be displayed as part of an image on a screen or monitor, and may be read or decoded using a mobile technology platform such as a mobile phone or PDA.

The machine readable codes described herein will preferably be implemented with suitable characteristics to ensure that the code will be machine readable in the captured image. Various parameters may affect machine readability and hence will be controlled for this purpose, including such code aspects as reflectance, symbol contrast, edge contrast, modulation, decidability, grid uniformity and axial uniformity.

The machine readable codes used in the systems and methodologies described herein may encode virtually any type of information. For example, the encoded information may be utilized to enhance awareness of a specific brand, event or cause.

The above description of the present invention is illustrative, and is not intended to be limiting. It will thus be appreciated that various additions, substitutions and modifications may be made to the above described embodiments without departing from the scope of the present invention. Accordingly, the scope of the present invention should be construed in reference to the appended claims.

1-16. (canceled)

17. A method for disseminating information, comprising:
determining the imaging schedule for imaging of a geographic region by an organization that captures images of geographic regions by aircraft or spacecraft, wherein the captured images are posted to a website; and
before and proximal to the scheduled imaging of the region, creating an artifact in the region such that an image of the artifact is present in at least one of the captured images, wherein the image of the artifact contains machine readable code.

18. The method of claim 17, wherein the region includes a building with a rooftop, and further comprising placing the artifact on the rooftop.

19. The method of claim 17, wherein the machine readable code is a two-dimensional bar code.

20. The method of claim 17, wherein the machine readable code is a matrix bar code.

21. The method of claim 17, wherein the machine readable code is a QR (quick response) code.

22. The method of claim 17, further comprising:
creating a hyperlink between the machine readable artifact and a web page such that, when the hyperlink is selected by a browser of the website, the browser is redirected to the web page.

23. The method of claim 17, wherein the resolution of the captured images is at least 20 m/pixel.

24. The method of claim 17, wherein the resolution of the captured images is at least 15 m/pixel.

25. The method of claim 17, wherein the resolution of the captured images is at least 5 m/pixel.

26. The method of claim 17, wherein the resolution of the captured images is at least 2.5 m/pixel.

27. The method of claim 17, wherein the resolution of the captured images is at least 0.5 m/pixel.

28. The method of claim 17, wherein creating an artifact in the region includes projecting an image onto a geographic feature in the region.

29. The method of claim 17, wherein creating an artifact in the region includes assembling the artifact from physical objects.

30. The method of claim 29, wherein the physical objects are selected from the group consisting of cars, shopping carts, bricks, and bales of hay.

31. The method of claim 17, wherein creating an artifact in the region includes painting the artifact on a substrate.

32. The method of claim 17, wherein disseminating information includes advertising goods or services.

33. A method for placing an artifact on a property, the method comprising:
identifying a plurality of candidate properties for the placement of an artifact that comprises a machine readable code which links to a webpage;
negotiating pricing terms for placement of the artifact on each of said plurality of candidate properties;
selecting at least one of the candidate properties for placement of the artifact;
determining the imaging schedule for imaging of a geographic region by an organization that captures images of geographic regions by aircraft or spacecraft, wherein the captured images are posted to a website, and wherein the geographic region contains at least one of the selected properties; and
before and proximal to the scheduled imaging of the region, placing the artifact on the at least one selected properties such that an image of the artifact is present in at least one of the captured images.

34. The method of claim 33, wherein selecting at least one of the candidate properties for placement of the artifact occurs in consultation with a client that provides content for the web page that the machine readable code links to.

35. A method for placing an artifact on a property, the method comprising:
maintaining a database of properties for which the owner has agreed to pricing terms for the placement of an artifact on the property, wherein the database includes a unique identifier for each property listed, and the pricing terms associated with that property;
obtaining, from a client, a selection of at least one property from the database for the placement of an artifact;
determining the imaging schedule for imaging of a geographic region by an organization that captures images of geographic regions by aircraft or spacecraft, wherein the captured images are posted to a website, and wherein the geographic region contains at least one of the selected properties; and
before and proximal to the scheduled imaging of the region, placing the artifact on the at least one selected properties such that an image of the artifact is present in at least one of the captured images.

36. The method of claim 35, wherein the machine readable code links to a webpage associated with the client.

37. The method of claim 35, wherein maintaining a database of properties includes soliciting offers from a plurality of property owners for the placement of an artifact on the property owners' properties.

38. (canceled)
